(19) United States
(12) Patent Application Publication
(10) Pub. No.: US 2006/0173641 A1
(43) Pub. Date: Aug. 3, 2006

(54) Current mode waveform generator followed by a voltage mode buffer

(76) Inventors: Geoffrey Haigh, Boxford, MA (US); Anthony E. Turvey, Reading, MA (US)

Correspondence Address: BROMBERG & SUNSTEIN LLP, 125 SUMMER STREET, BOSTON, MA, 02110-1618, US

(21) Appl. No.: 11/304,068

(22) Filed: Dec. 15, 2005

Related U.S. Application Data
(60) Provisional application No. 60/636,373, filed on Dec. 15, 2004.

(51) Int. Cl. G06F 13/40

(52) U.S. Cl. 702/64

(57) ABSTRACT

A power saving circuit that creates a fast changing high resolution signal for testing of a pin of a device under test is disclosed. The circuit of the invention includes a current mode waveform generator followed by a voltage mode buffer. For example, the current mode waveform generator may be an A-linear or KT-linear stage. The voltage mode buffer may be a class AB output stage. By including the voltage mode buffer after the current mode waveform generator, the required standing power for the driver circuit is reduced when compared to using a current mode waveform generator alone.

### CROSS REFERENCE TO RELATED APPLICATIONS

The present application claims priority from U.S. Provisional Patent Application No. 60/636,373 filed on Dec. 15, 2004, entitled “Class A Drive Architecture in Front of Classic AB Driver Output Stage,” which is incorporated herein by reference in its entirety.

### TECHNICAL FIELD AND BACKGROUND ART

The present invention relates to drivers and more specifically to drivers for use in automatic testing equipment (ATE). It is known in the prior art to use class A-linear or KT-Linear stages for generating a voltage waveform and coupling such a stage to the pin of a device under test. Normally there is an associated 50 ohm load at the pin or wire that connects the driver stage to the device under test. The output resistance of the driver is preferably matched to this resistance. As such, these driver stages require large standing power due to the size of the current sources to produce Volt level voltage swings.

FIG. 1 shows a prior art driver architecture 100. A current mode driver 110 having a current generator 135 and an effective output resistance Rₓ 115 coupled via a cable having an impedance R 120 to a device under test (DUT) 130. Rₓ 115 is preferably matched to R 120 which is typically 50 ohms. Since the output resistance is a fixed variable, in order to produce a desired voltage waveform at the DUT, the current must be varied. Thus, since the effective resistance at node A is equal to

$$\frac{R \cdot {R}_{x}}{R + {R}_{x} } ( 25 ohms ) ,$$

in order to change the value of the output voltage, current must be sourced and sunk from the current mode driver (V_{waveform}=i·25 ohms) requiring a great amount of power to maintain the changing voltage levels.

### SUMMARY OF THE INVENTION

In a first embodiment of the invention, there is provided a power saving circuit that creates a fast changing high resolution signal for testing of a pin of a device under test. The circuit of the invention includes a current mode waveform generator followed by a voltage mode buffer. For example, the current mode waveform generator may be an A-linear or KT-linear stage. A current mode waveform generator is a current generator generating a current of programmable shape in the time domain wherein the current is passed through a resistance to define a voltage waveform. The voltage mode buffer may be a class AB output stage. By including the voltage mode buffer after the current mode waveform generator, the required standing power for the circuit is reduced when compared to using a current mode waveform generator alone. Since the voltage mode buffer rather than the current mode waveform generator is directly coupled to the impedance of the wire or pin via a matching resistor, the output resistance of the current mode waveform generator does not need to be matched to the wire/pin impedance. Therefore, the output impedance of the current mode waveform generator can be much larger than the resistance necessary to match the cable/pin. As a result, the voltage waveform generated by the current mode waveform generator can be controlled by changing the amount of current or changing the size of the output resistance. As a result, voltage swings can be created with smaller currents and therefore smaller current sources. Since the standing power is based solely on the current and voltage, the resistance can be made large.

In a further embodiment, the circuit includes a shaping circuit between the current mode waveform generator and the voltage mode buffer. The shaping circuit shapes the signal so that the rise time of the voltage waveform is compatible with the slew rate of the voltage mode buffer. The shaping circuit shapes the output so that the input signal transitions between levels like a linear ramp rather than the exponential transition shape that is associated with an RC circuit (The output of the current mode waveform generator has RC rising and falling edges). The shaping circuit may be programmable and can be programmed to allow the shape to rise at a rate that is compatible with the AB stage.

### BRIEF DESCRIPTION OF THE DRAWINGS

The foregoing features of the invention will be more readily understood by reference to the following detailed description, taken with reference to the accompanying drawings, in which:

FIG. 1 is a prior art driver structure;

FIG. 2 is a first embodiment of the invention showing a driver structure;

FIG. 3 is a second embodiment of the invention showing a shaping circuit incorporated into the driver structure;

FIG. 3A is a graph showing voltage level over time for a transition with and without a shaping circuit;

FIG. 3B is a schematic showing one embodiment of a shaping circuit which is a diode bridge with programmable current sources;

FIG. 4 is a schematic showing an embodiment of the invention including logic for steering and programming current sources for producing a voltage waveform;

FIG. 5A is a graph showing the standing power for a current mode waveform generator as embodied in the present invention as compared to the standing power for a prior art current mode waveform generator;

FIG. 5B is a graph showing the I-V curve for a voltage mode buffer; and

FIG. 5C is a graph showing that the overall standing power for the present invention that includes a current mode waveform generator followed by a voltage mode buffer is less than the standing power for a prior art current mode waveform generator.

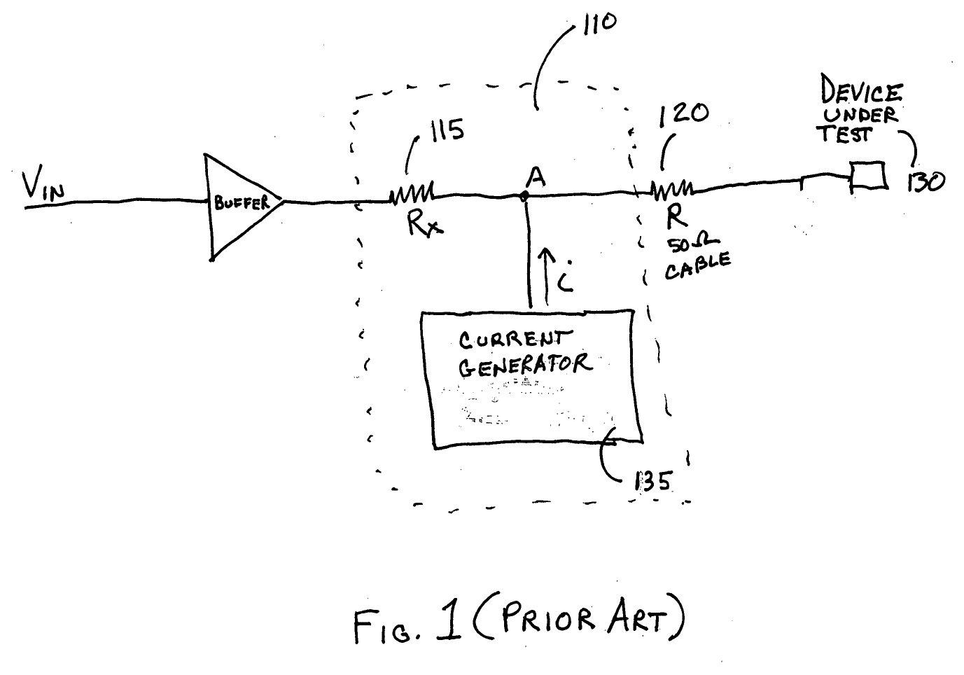

### DETAILED DESCRIPTION OF SPECIFIC EMBODIMENTS

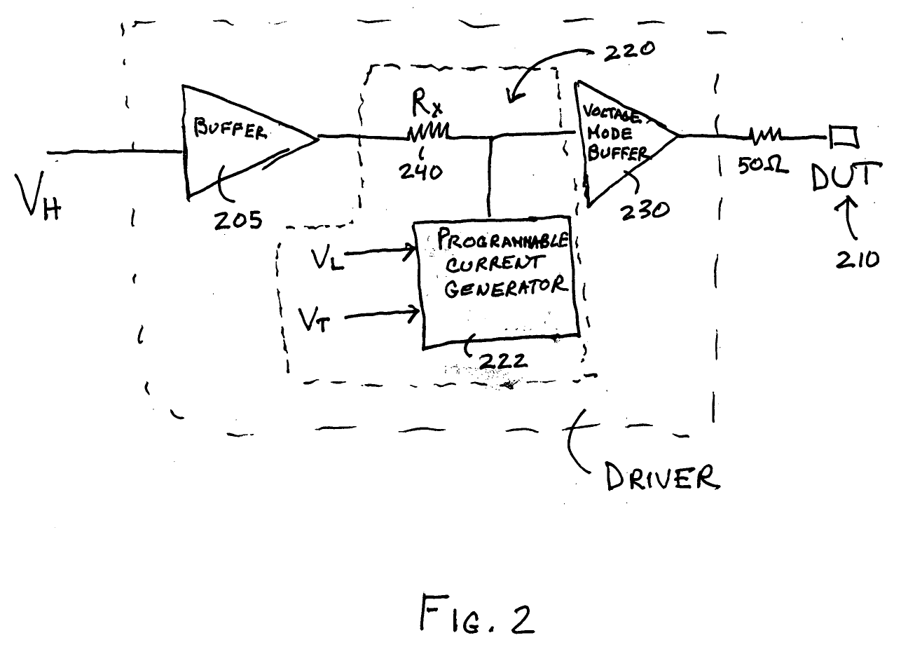

FIG. 2 is a block diagram of a first embodiment of the invention. The figure shows a driver circuit 200 coupled to a pin of a device under test (DUT) 210. A current mode waveform generator 220 generates a driver signal, for example Vh, Vt, or Vl. The current mode waveform generator includes a programmable current generator 222 that generates a current of programmable shape in the time domain and a resistor that receives the current creating a voltage waveform. Examples of current mode waveform generators include but are not limited to a class A linear amplifier as described in U.S. Pat. No. 6,677,775 and the KT-linear driver as described in U.S. patent application Ser. No. 10/946,483 filed Sep. 21, 2004 which are both incorporated herein by reference in their entirety. The waveform signal is provided to a voltage mode buffer 230 that is coupled to the pin of the DUT through a cable having an impedance. The impedance of the cable is generally 50ohms. In the embodiment that is shown, an input voltage signal is passed through a buffer as an input into the current mode waveform generator. The current mode waveform generator includes one or more current sources (not shown) switchably connected to the Vₕ signal through a resistor Rₓ 240. If the desired voltage signal is Vₕ the current sources are switchably disconnected from the output node and Vₕ is passed from the input through a buffer circuit 205 and the current mode waveform generator 220 to the voltage mode buffer 230. If a different voltage is desired, the current sources within the current mode waveform generator 220 are coupled to the output pin and Rₓ. The voltage at the output of the current mode waveform generator 220 is reduced from Vₕ to Vₕ−(i·Rₓ) if a voltage lower than Vₕ is desired and can be equal to Vₕ+(i·Rₓ) if a voltage higher than Vₕ is desired. Thus, the voltage waveform can be defined by having the current mode waveform generator 220 provide different current levels. Additionally, since the resistor Rₓ 240 is not coupled to the DUT, the resistor Rₓ 240 need not be matched to the pin or cable's input impedance. As a result, the value of Rₓ 240 can be made larger than the typical 50 Ohm output impedance requirement. By increasing the size of Rₓ 240 the current sources within the current mode waveform generator can be made proportionally smaller and therefore require less standing power.

In the embodiment that is shown, the waveform passes through a voltage mode buffer 230. The voltage mode buffer 230 may be a typical AB-type amplifier output stage, such as a complementary emitter follower. The voltage mode buffer 230 is constructed to have an output impedance that is matched to the cable/input pin of the DUT. In order to guarantee an accurate output waveform, the slew rate of the voltage mode buffer 230 must be fast enough to accommodate the transitions provided by the current mode waveform generator. The transition at the input to the voltage mode buffer will behave like an RC circuit defined by Rₓ and the input capacitance of the voltage mode buffer. Thus, when a transition is produced between a low and a high state, the waveform increases exponentially and when the waveform transitions between a high and a low state, the waveform decreases exponentially.

FIG. 3 shows an alternative embodiment in which a shaping circuit 250 is positioned between the current mode waveform generator 220 and the voltage mode buffer 230. The shaping circuit 250 may be a filter, such as a multi-pole Bessel filter. Bessel filters are desirable in such applications because the filter is symmetric has a minimal settling time and is critically damped. Other filters, such as Chebyshev and Butterworth filters may be used depending upon the filtering properties that are desired. For example, if an integrated circuit manufacturer desires some overshoot, an under damped filter may be used. In order to accommodate the slew rate of the voltage mode buffer, the shaping filter will alter the transitional shape of the waveform. The waveform, which as previously described behaved as an RC circuit without the shaping circuit and thus had an exponential transition between a low and a high state, is transformed by the shaping circuit to behave more like a linear ramping function as shown in FIG. 3A. Other filters may also be used to slow the transition rate between states of the current mode waveform generator, such as a diode bridge circuit with programmable current sources as shown in FIG. 3B. The diode bridge 300 receives in the waveform 310 from the current mode waveform generator. Depending on the difference in voltage levels between the voltage at the output of the current mode waveform generator and the voltage at the input (on the capacitor) 320 of the voltage mode buffer, current will be sourced or sunk from the capacitor by the programmable current sources 330. The sourcing or sinking of the current will act in a substantially linear fashion, and therefore, the voltage will ramp in a substantially linear fashion. By varying the size of the programmable current source the slope of the I/V curve can be varied to accommodate the slew rate limitation of the voltage mode buffer.

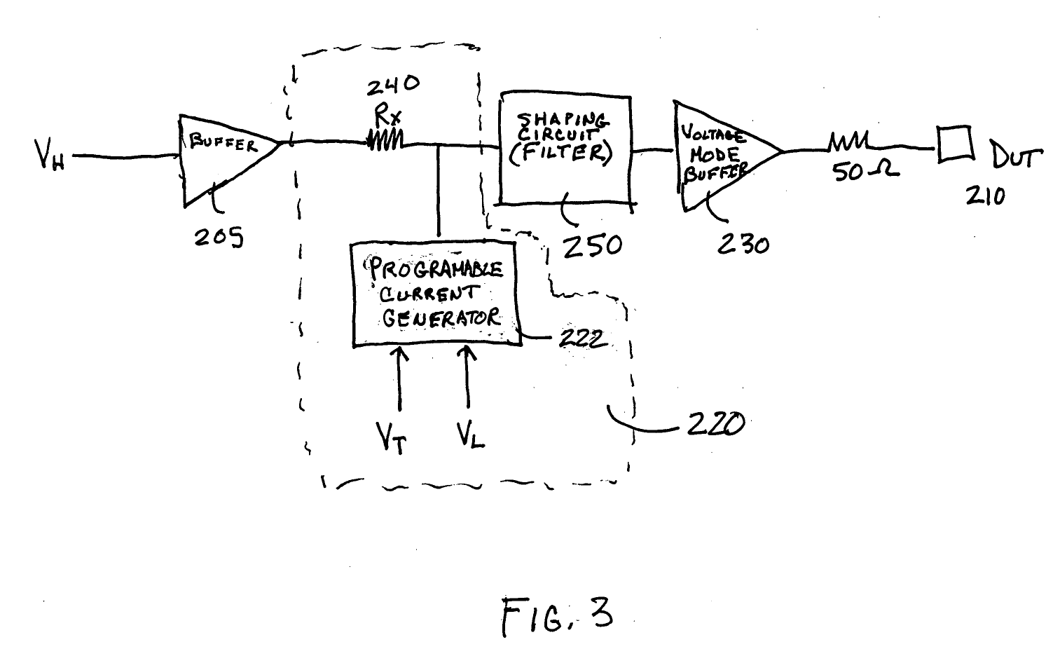

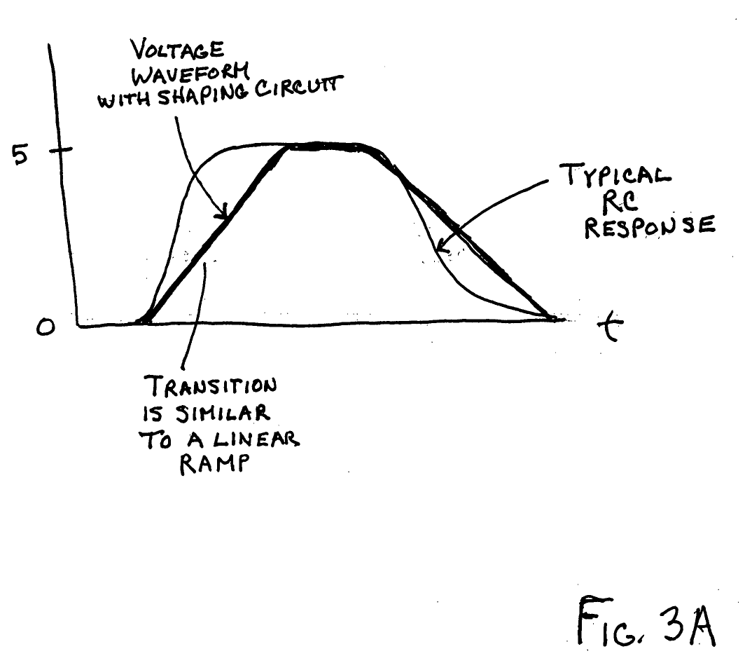

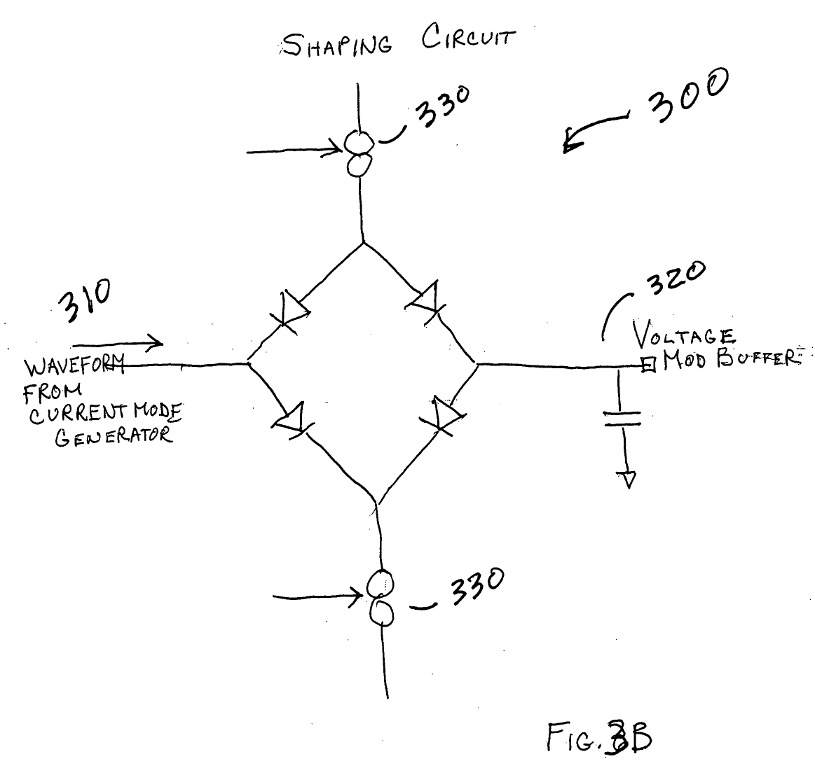

FIG. 4 is circuit diagram showing an embodiment of the invention including an exemplary current mode waveform generator 400 followed by a voltage mode buffer 410. As shown, the current mode waveform generator 400 is constructed as a current steering circuit. Voltage Vh is passed through a buffer 420 to the input of the current mode waveform generator to node A. Current mode waveform generators are preferred for creating voltage waveform signals due to the quick switching speeds and settling times.

To obtain a desired voltage level, high speed differential logic 430 such as ECL (emitter coupled logic), PECL (positive referenced emitter coupled logic), and CML (current mode logic) causes switches S₁ to Sₙ to switch depending on the desired waveform voltage level. Control signals are received by the high speed differential logic 430 providing an indication of the desired waveform. If the desired waveform voltage is Vₕ, the logic will cause the switches S₁ to Sₙ to couple to node A wherein the current from the current sources CS₁ to CSₙ will be sunk by the buffer circuit. It should be understood that n can be any positive number (1 . . .n) and therefore there may be more than the two current sources that are shown in this embodiment. If the voltage V_{L} is desired, the high speed logic will cause switch S₁ to switch to node B and thus the voltage at node B will be equal to V_{b}=Vₕ−i_{cs1}·Rₓ. The high speed logic will also program i_{ce1} using a digital to analog converter. The switch Sₙ will stay coupled to node A and will be sunk by the buffer. The voltage Vₕ which is present at node A is pulled down as the result of the current source CS₁ and the resistor Rₓ. Thus, both the current source and the resistor can be sized according to the desired output voltage level at node B. Similarly, if Vₜ is desired, the high speed logic will cause switch S₁ to switch to node A and switch Sₙ to switch to node B. The high speed logic will also program CSₙ to an appropriate current level to make V_{b}=Vₜ,=Vₕ−i_{cs1}·Rₓ. Thus, by programming the current source the proper output voltage level is produced.

The voltage waveform is input into the voltage mode buffer. The voltage mode buffer is designed to have a high input resistance, to have a very low input capacitance, and a 50 ohm cable matching impedance. As already stated the voltage mode buffer may be a class AB output stage, such as a complementary emitter follower. Other Class AB output stages may be used as are known in the art. Examples of Class AB output stages can be found in U.S. Pat. No. 4,639,685, U.S. Pat. No. 5,049,653, and in the article entitled “Low Output Impedance Class AB Bipolar Buffer,” from the IEEE Proceedings Electronics Letters pg. 1662 Vol. 33, Sep. 25, 1997. In other embodiments a shaping circuit is placed between the current mode waveform generator and the voltage mode buffer. If the shaping circuit is a filter (i.e. Bessel etc.) then the input capacitance of the voltage mode buffer can become part of the filter parameters.

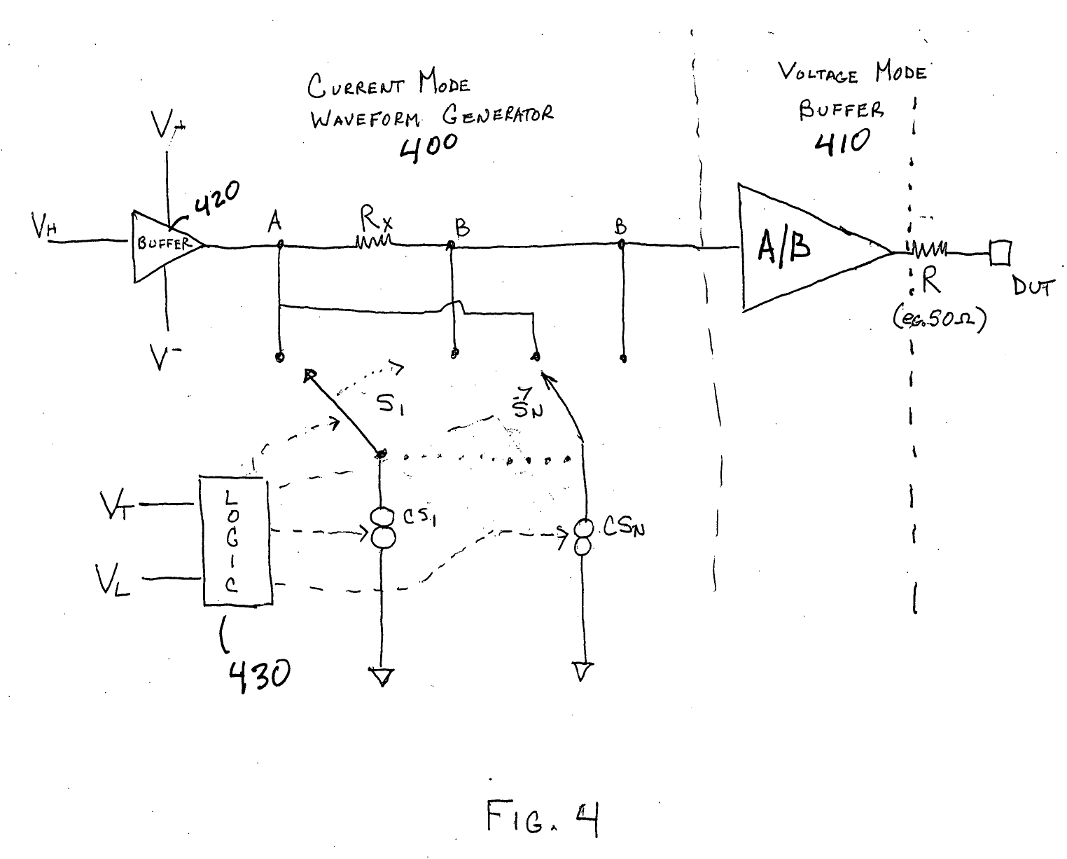

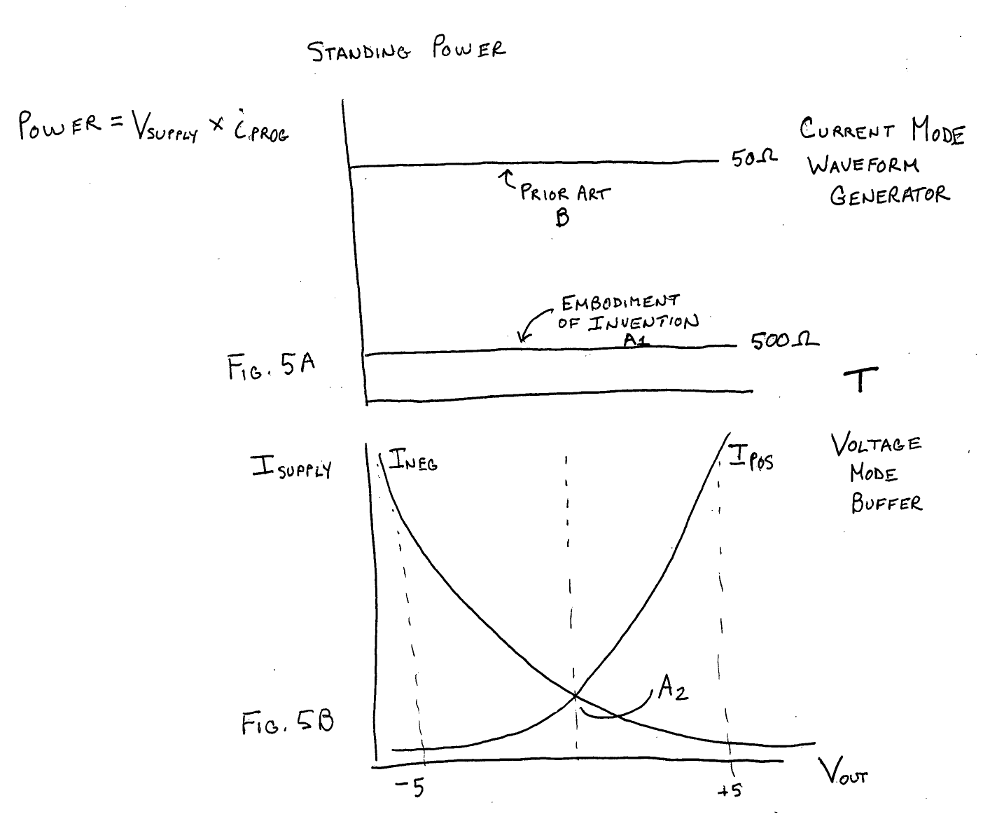

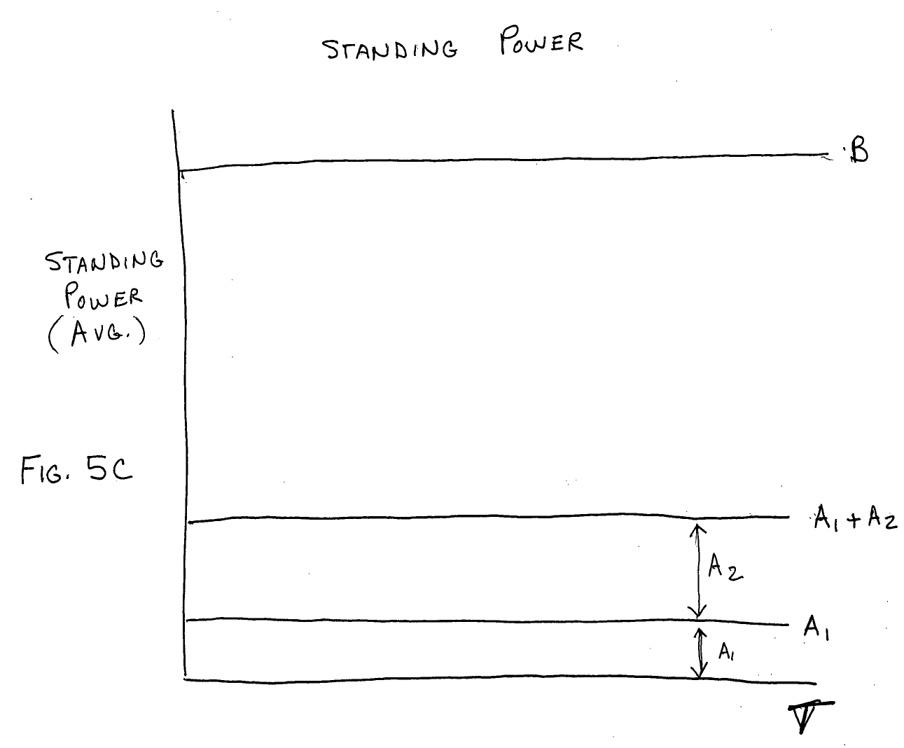

FIG. 5A shows a graph of the standing power needed for a prior art current mode waveform generator B and an embodiment of the current mode waveform generator A₁ of the present invention, such as that shown in FIG. 4. The difference in the standing power is due to the fact that the output resistor of the present invention does not need to be matched to the resistance of the cable/input to the device under test and therefore the output resistance can be made larger and the current sources smaller. FIG. 5B shows current/voltage graph for the voltage mode buffer. The average current and voltage and therefore the standing power for the voltage mode buffer is located at point A2. The standing power can be calculated as P=IV at point A2. FIG. 5C shows the standing power for the current mode waveform generator (A1) which when added to the standing power for the voltage mode buffer (A2) is still less than the standing power for the prior art current mode waveform generator (B).

Although various exemplary embodiments of the invention have been disclosed, it should be apparent to those skilled in the art that various changes and modifications can be made that will achieve some of the advantages of the invention without departing from the true scope of the invention. These and other obvious modifications are intended to be covered by the appended claims.

What is claimed is:

1. A driver for providing a waveform to a pin of a device under test comprising:
a current mode waveform generator having an output and generating the waveform;
a voltage mode buffer receiving the waveform from the output of the current mode waveform generator and providing the waveform to the pin of the device under test.

2. A driver according to claim 1, further comprising:
a filter positioned between the current mode waveform generator and the voltage mode buffer for shaping the waveform;

3. A driver according to claim 1, wherein the waveform output from the current mode waveform generator has RC rising and falling edges.

4. A driver according to claim 1, wherein the current mode waveform generator is a KT-linear stage.

5. A driver according to claim 1, wherein the current mode waveform generator is an A-linear stage.

6. A driver according to claim 1, wherein the voltage mode buffer is an AB output stage.

7. A driver according to claim 2, wherein the filter shapes the waveform so that the slew rate of the filter is less than the slew rate of the voltage mode buffer.

8. A driver according to claim 1 wherein the current mode waveform generator has a high output impedance compared to that of the pin of the device under test and the voltage mode buffer buffers the high output impedance from the impedance of the device under test.

9. A driver according to claim 1, wherein the voltage mode buffer has an output impedance equal to an input impedance of the device under test.

10. The driver according to claim 9, wherein the current mode waveform generator has a high output impedance compared to that of the pin of the device under test and the voltage mode buffer buffers the high output impedance from the impedance of the device under test.

11. A method for using a current mode waveform generator to provide a voltage waveform to a device under test, the method comprising:
providing a control signal to the current mode waveform generator causing the current mode waveform generator to generate a voltage waveform;
receiving the voltage waveform into a voltage mode buffer; and
outputting the voltage waveform from the voltage mode buffer to a pin of the device under test.

12. The method according to claim 11, wherein the voltage mode buffer has an output impedance matched to an input impedance of the pin of the device under test.

13. The method according to claim 11, wherein the voltage mode buffer has an input slew rate further comprising:
shaping the voltage waveform that is output from the current mode waveform generator so the voltage waveform has a slew rate compatible with the voltage mode buffer.

14. The method according to claim 13 wherein shaping occurs in a shaping circuit

15. The method according to claim 11 wherein the current mode waveform generator is a KT-linear stage.

16. The method according to claim 11 wherein the current mode waveform generator is a A-linear stage.

17. The method according to claim 11, wherein the voltage mode buffer is a AB output stage.

18. The method according to claim 1 1, wherein the current mode waveform generator includes a plurality of switchable current sources and an output impedance; further comprising:
in response to the control signal selecting one or more of the switchable current sources so an associated current from the selected current sources passes through the output impedance creating the voltage waveform.

19. The driver according to claim 2, wherein the filter is a multi-pole filter.

20. The driver according to claim 2, wherein the filter is a Bessel filter.
